(19) United States
(12) Patent Application Publication
(10) Pub. No.: US 2002/0100808 A1
(43) Pub. Date: Aug. 1, 2002

(54) Smart card having multiple controlled access electronic pockets

(76) Inventors: William Daniel Norwood, Tallahasse, FL (US); Rodney F. Allen JR., Tallahasse, FL (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 09/683,201

(22) Filed: Nov. 30, 2001

Related U.S. Application Data
(63) Continuation of application No. 09/772,579, filed on Jan. 30, 2001.
(63) Continuation of application No. 09/772,706, filed on Jan. 30, 2001.
(63) Continuation of application No. 09/772,625, filed on Jan. 30, 2001.

(51) Int. Cl. G06K 7/00

(52) U.S. Cl. 235/486

(57) ABSTRACT

A multifunction smart card having a purse with a plurality of pockets capable of registering a stored value limited to a predetermined purpose. The system in which the smart card is used includes the smart card, a smart card terminal for populating data on the smart card, a funds terminal for entering data associated with an account from which funds registered to a smart card pocket, and an institution and merchant terminal associated with institutional and merchant data for use of the smart card. Each component of the system is connected in a network to central processing unit linked to a database containing component associated records. Upon receipt of a signal in the network, the central processing unit processing unit records transactions made with the card. The system is capable of settlement between the funder account and merchants on a timed basis.

### CROSS REFERENCE TO RELATED APPLICATIONS

This application is a continuation in part of our application Ser. No. 09/772,579, Web-Based Smart Card System and Method for Checking Cardholder Status Information to Verify Eligibility for Specific Events; Ser. No. 09/772,706, Vehicle Service and Maintenance Tracking System; and Ser. No. 09/772,625, Paperless System for the Online and Offline Collection of Data in Elections and Surveys, each filed Jan. 30, 2001 and incorporated by reference herein as if set out in full.

### BACKGROUND OF INVENTION

The present invention relates to a multiple function smart card. More particularly, the present invention relates, inter alia, to a network accessible smart card having multiple functions and a stored value purse with discrete pockets, each, in a cash storage mode, capable of being funded or allocated for a predetermined use or purpose and, in a disbursement mode, restricted to the predetermined use or purpose. Individual transactions utilizing the smart card, and net settlement of aggregate transactions registered utilizing the smart cards, are conducted in a network environment or via the Internet.

Smart cards may include a memory chip or a mini-microcomputer activated upon use of the card. Varieties of smart cards may be preloaded with a predetermined value such as cash, cash equivalent, token, and the like. Upon each instance of use of the smart card, the stored value is debited in an amount corresponding to the transaction. When the preloaded cash or other value stored in the card memory is exhausted, the card is no longer useful as value currency. Varieties of smart cards provide an ability to read data and overwrite data on the card and to record and store records of transactions and other data. See, for example, U.S. Pat. No. 5,884,292, Baker, et al., issued Mar. 16, 1999, System For Smart Card Funds Refill; and U.S. Pat. No. 5,857,079, Claus, et al., issued Jan. 5, 1999, Smart Card for Automatic Financial Records. Other types of smart cards allow a user to up-load and download applications and data. Smart cards my also include functionality to validate a user's identity, to allow the user to purchase products without physically going to a shop, and to collect loyalty information.

Smart cards are used in educational, governmental and commercial environments, for example, as identity cards to permit access to facilities and events, to maintain data records associated with the user, and as a mechanism to transact cashless financial transactions. Users are currently able to store a predetermined amount of funds or other value on a smart card.

A disadvantage of currently available smart cards is that a user must carry different cards for different functionalities such as identification, authorization and transactions. Another disadvantage with current smart cards is that the cards do not restrict the type of use to which value stored in the card may be applied or spent by the user. For example, even though a parent may populate a smart card with funds intended for a student's school-related purchases (books), the student may nevertheless use the stored funds without restriction for other purposes (entertainment). Parents cannot control the student's use of the stored value. A parent's credit file may be associated with the student's smart card. Credit and payment issues for both the parent and student may develop as a result of a student's misuse of funds allocated to, or accessible by, a student's smart card.

A further disadvantage of current stored value smart cards is that cash must be allocated to a card purse. Unless large amounts of cash are tied up on the card, the card may have insufficient funds for a purchase. In addition stored value in the form of cash allocated to the card may be lost when the card is lost. A need exists for a system to indirectly reallocate funds to a card quickly and to move cash efficiently to and from different accounts based on transactions involving the smart card.

### SUMMARY OF INVENTION

The invention consists of a multiple function stored value smart card associated with a network or web-based system that includes a central server site that acts as a portal through which educational, governmental and commercial communities may move and track information and financial data through the use of a smart card. The system provides a universal transaction vehicle for closed or open interfaces and financial services. Although any user application is contemplated, the example used throughout this application is directed to college campus and student applications.

The present invention comprises a multiple function smart card associated with conventional uses such as access to events and buildings, voting, eligibility determination, Internet access, payment of financial instruments and other paperless purchases. The invention further provides an improved operational efficiency for controlled cashless payments based on an account linked to the card, as well as efficient settlement of the transactions made by a user of the card.

The invention has the advantage in that, in addition to identification and access to institution elements and activities, it allows a smart card funder (namely, a parent, in the college instance of the example) to predefine one or more given pockets in an electronic purse according to a predetermined funding application associated with an individual pocket. Funds disbursement is controlled. The incidence of abuse of the stored value through expenditure of the value for purposes for which the funds were not intended, for example, a student's use of book money for concert tickets, is reduced.

The present system also effects daily settlement of transactions conducted with the smart card, providing a convenient and timely method for merchants to collect funds, and for funders to control cash flow incident to stored value and to expenditures of the value made with the smart card.

The system and smart card of the invention allows network or web-based card issuance at user sites, such as at a computer in a student's dorm room linked to the Internet at the student's school (in the college example), but could also include home, government and community sites. The system handles all aspects of card issuance and personalization. The user accesses specific file information located in a database attached to a central processing unit of the system to populate the smart card with personal identification information, institutional access and eligibility information and an electronic purse with one or more (predetermined or user determined) pockets which are designated for transactions in a specific category. The system monitors and tracks a user's use of the card, allows access to institutional activities and elements, and performs transaction processing and settlement. The user monitoring and tracking aspects of the invention interactively work in conjunction with uses of the smart card. Access functions and individual transactions are monitored and recorded on the card and uploaded to the database linked to the central processing unit. The electronic purse utilizes pockets capable of storing different values allocated for specific categories of purchases. A user may use the card to operate networked as well as offline traditional coin-operated machines, and may make purchases make based on information viewed over the Internet or directly from merchant terminals. Merchants include institutional as well as non-institutional sites and also includes offline and networked coin operated machines. The transaction and settlement process used for settling electronic purse transactions of the system is network or Internet-based. The system updates and settles financial transactions on a periodic, such as daily, basis.

Additional features of the system include voting, and access to the Internet to use personal email accounts and view local institution information and community news.

The invention is described more fully in the drawings and the following description of the preferred embodiment considered in conjunction with the drawings, in which:

### BRIEF DESCRIPTION OF DRAWINGS

FIGS. 1A and 1B respectively show the front and reverse sides of a smart card useful with the system.

FIG. 2 is a diagram of the characteristics of a multiple function smart card including controlled access stored values in different pockets of a purse.

FIG. 3 is an relational chart showing the smart card system through stages of the card's creation, and use for purchasing, access, loan payment and Internet access with respect to a master server.

FIG. 4 is a high-level data flow diagram of the smart card controlled access purse and purchasing and settlement system.

FIG. 5 is a network diagram for a multiple function smart card network transaction settlement system showing the network components and participants and their interrelationship.

### DETAILED DESCRIPTION

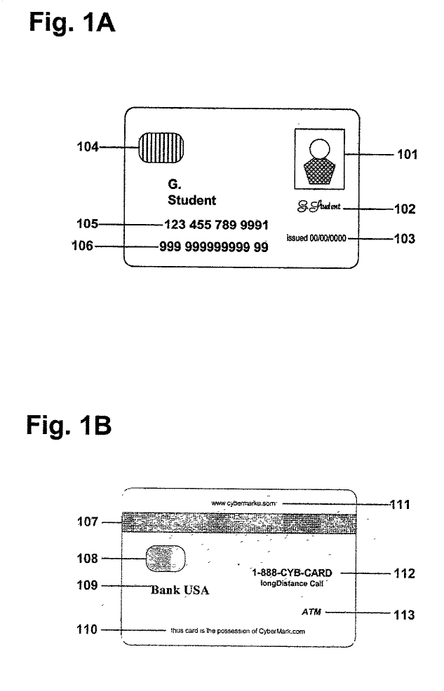

In more detail, FIG. 1A shows features of the front a smart card useful with the system. The card includes a digitized color photo 101 and a digitized signature 102. The date of issue i03 is included on the face of the card. The microprocessor chip 104 is imbedded in the card. In the preferred embodiment, the student identification number 105 and library number 106 are shown on the face of the card.

FIG. 1B shows features listed of the reverse side of the card. The card includes a magnetic stripe 107 and a logo 108 as well as a bank partner logo 109. A disclaimer 110 and the web address of the system 111 are listed on the reverse side of the card. The access number 112 for calling card use and ATM's useable in the system 113 are also included.

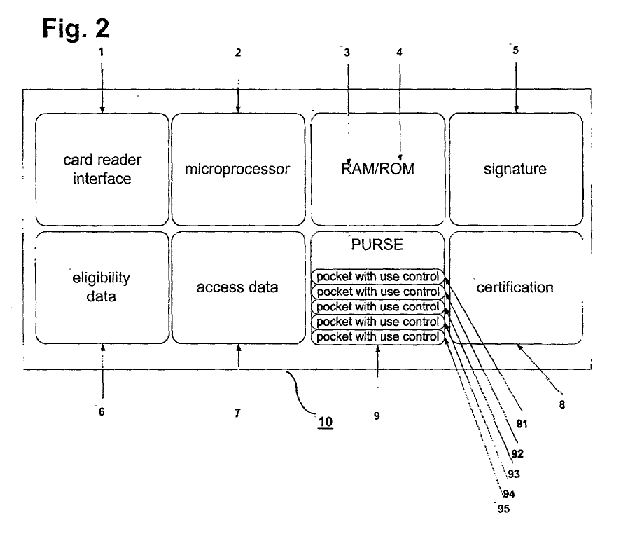

FIG. 2 shows the components of a multiple function smart card 10. The card 10 includes a card reader interface 1, a microprocessor 2, RAM 3 and ROM 4, a digital signature 5 for both private and public encryption, eligibility data 6 and access data 7 at the institution, a digital certificate 8 used to authenticate identity in an online environment, and a purse 9 with pockets 91-96 where values associated with a funder's account are stored and updated. The pockets 91-96 include a mechanism that allows a funder to control the use of the individual pocket 91-96 for specific purchases.

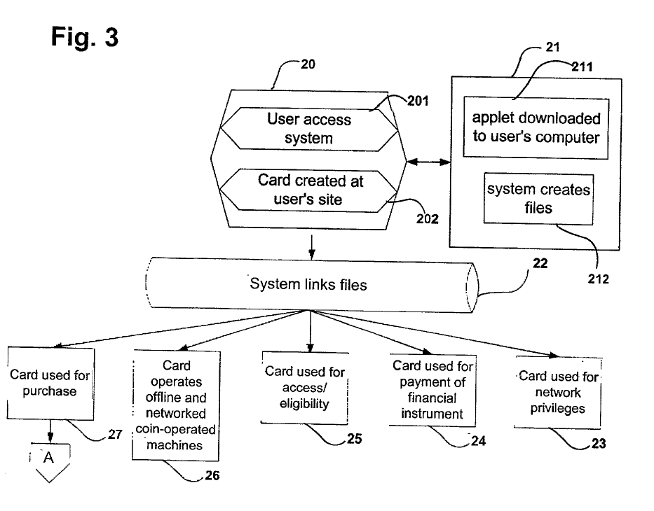

FIG. 3 depicts an overview of the smart card system. A card user accesses the smart card system 201 via a network, such as the Internet, using a computer 20, such a personal computer, a cell phone, etc. In the example, the user accesses the system's web page 200. During the interface, the web page downloads a Java applet to the user's computer 211 to allow communication between the card and a smart card reader to create the card 202, and files are created on the system 212.

The server of the system links files in a database to the card 22. The card may be used for access to the Internet 23, to reimburse financial instruments 24, to access events and activities 25, operate networked and offline coin-operated machines 26, and make purchases both online and at system merchants 27.

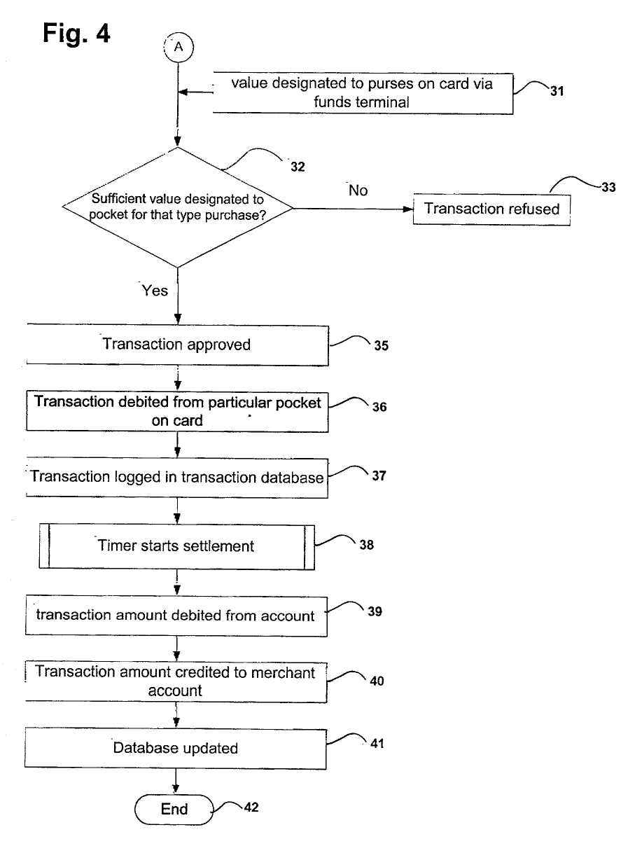

FIG. 4 depicts the steps involved when the card is used to make a purchase. A funder enters funds account information and designates cash values for pockets on the smart card 31. The funder may specify that any of the pockets 91-96 may be designated as specific purchase pockets. When a user uses the smart card to make a purchase, a query as to sufficient funds and correct category purchase for that pocket is performed 32. If the pocket contains no value or the user attempts to purchase an item that is not allowed by that pocket, the transaction is refused 33. If the value in the pocket is sufficient and the type of purchase is allowed for that pocket, the purchase is approved 35. The value of the purchase is debited from the particular pocket 36 and the amount of the transaction and merchant identification information is uploaded to the database 37. At a given time, settlement occurs 38. The values designated from the approved purchases are debited from the funder's account electronically 39. A corresponding amount is electronically transmitted to the merchant account 40. Merchant accounts 40 include offline and networked coin operated machines, website and bricks and mortar retail sites, and those related to institutional purchases and payments. The database is updated 41 and the process ends 42 until a signal from one of the components reactivates the system.

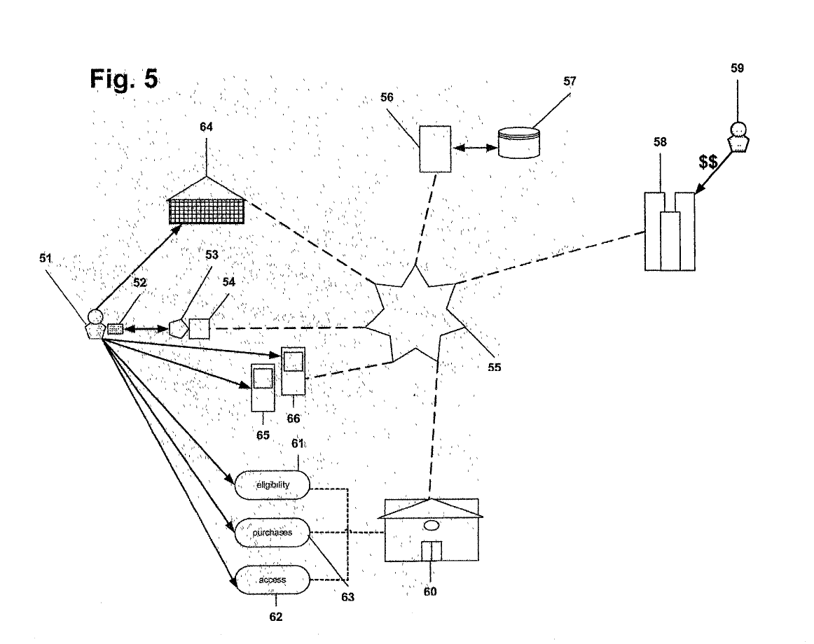

FIG. 5 is a diagram of the settlement system. A user 51 creates a multiple function smart card 52 at a smart card reader 53 connected from a secured site 54 to a network 55. The secure site may be any processor, such as personal computer or a cell phone. The network 55 may be a closed network or the Internet. The network 55 includes a central processing unit (CPU) 56 connected to a database 57. The user 51 inputs data concerning the user, such as a password. The CPU 56 downloads a Java applet to the user's computer 54 to allow the card reader 53 to communicate with the card 52. The database 57 contains data transmitted from a secured funds terminal 58 by one or more than one funder 59. The data includes data for an electronically accessible account, values for pockets of a purse on a specific user's smart card 52 and restrictions as to the user's ability to make purchases from that pocket of the purse. Restrictions may be categorical, such as school supplies or specific, such as school loan repayment. The smart card 52 purse contains multiple pockets for which a funder 59 can designate a value and control access. The central processing unit 56 matches funder data to user data and downloads the linked funder data to the user's smart card to complete the creation of the smart card 52. The user's institution transmits data to the database 57 from a secured institution terminal 60. The institution enters data regarding the user's eligibility 61 for institution activities and access 62 to events and institutional elements, such as a campus library or chemistry lab. The system includes merchants, both web based and bricks and mortar sites, connected to the system through a secured merchant terminal 64. Merchant data, including a merchant account, is stored and updated in the database 57. The user 51 may then use the card 52 to participate in institution 60 activities based on eligibility 61 or access 62 institution elements. The user may use the card to execute transactions via the secured site 53 or at a merchant terminal 64. The institution 60 is also a merchant when the card 52 is used to make purchases 63, such as food and school supplies or to repay student loans. The user may also use the card to operate offline coin operated machines 65 as well as networked coin operated machines 66, such as laundry services, copiers, and vending machines.

In brief, the invention is a smart card having a purse with a plurality of pockets, each pocket capable of registering a stored value therein associated with a predetermined purpose, each pocket being further controlled with respect to transactions involving the pocket such that an expenditure of stored value associated with the pocket is restricted to the predetermined purpose of the pocket. The use of the smart card is controlled according to predetermined data associated with the card maintained in a central network database.

The smart card is useful in a transaction system that includes a smart card terminal for populating data on the smart card concerning a card user and for registering a stored value having a restricted purpose in at least one of the pockets; a funds terminal wherein funds data associated with an account from which funds registered to a smart card pocket is entered; a merchant terminal operable with the smart card wherein merchant data, including a merchant account and merchant purchase data with respect to use of the smart card are entered; and an institution terminal operable with the smart card wherein institution and card user data and institution use data with respect to use of the smart card are entered.

The terminals are interconnected in a network served by a central processing unit (CPU). The CPU is operatively interconnected with a database containing records of data associated with a card user, stored values having a restricted purpose in a pocket on the card user's card; funds associated with an account from which funds registered to a smart card pocket; a merchant and merchant purchases with respect to use of the smart card; and an institution and institution use data with respect to use of the smart card. Upon receipt of a data signal in the network from at least one of the smart card terminal, the funds terminal, the merchant terminal and the institution terminal, the CPU processes the data in the signal with respect to a card user, stored values having a restricted purpose in a pocket on the card user's card; funds associated with an account from which funds registered to a smart card pocket; a merchant and merchant purchases with respect to use of the smart card; and an institution and institution use data with respect to use of the smart card; according to predetermined criteria associated with the interrelationship of a card user, stored values having a restricted purpose in a pocket on the card user's card; funds associated with an account from which funds registered to a smart card pocket; a merchant and merchant purchases with respect to use of the smart card; and an institution and institution use data with respect to use of the smart card.

The CPU is capable of transmitting a software application comprising an executable card interface from the CPU for storage on the smart card terminal upon a request from the smart card terminal. The software application is preferable a Java applet.

Preferably, the CPU calculates funds debits and credits owing from and payable to the different pockets of the card and owing from and payable to the account from which the funds are registered and owing from and payable to the designated merchant account with respect to use of the smart card. The settlement of funds debits and credits between and among the smart card, the funds account, and the merchant is controlled by a predetermined event or schedule. The registration of value in card pockets, and the debiting of funds between the account from which the funds are registered to the card, and the merchant account is based upon activation of the central processing unit by the card.

The smart card may include a functionality, or other multiple functionalities, in addition to stored value in controlled access pockets, such as a functionality associated with accessibility, eligibility and network privileges.

The present invention is a system that uses a network to issue multifunctional smart cards to a user. The invention further allows for restriction of purchase ability from the pockets of the electronic purse of the smart card and effects settlement between a funder's account at a financial institution and a variety of merchant accounts. The system is a universal transaction vehicle for closed or open interfaces and financial services. The system includes a database located at a central processing unit housing information concerning merchants, institutions, transactions, funders and users.

The invention includes a web site that is accessible over a network such as the Internet. A card user, institution or funder accesses the web site and downloads software to use the system. The hardware at the user site includes a smart card reader. In the preferred embodiment, the smart card reader may be coupled to a student's personal computer linked to the Internet or incorporated into a cell phone with Internet access. The system downloads a Java applet for storage on the user's computer to interface the card reader with the card. The user uploads user specific data to the smart card from information located in a database linked to a central processing at the web site. Information is received from the funder and the institution. The system has ability to allow a card user to update his or her general information, an institution to update card user eligibility and access information, and a funder and merchants to update their respective information.

The funder and card user register online by inputting personal data such as postal address, e-mail address and credit card or bank account information. The inputted information is stored in card user specific electronic files in the database and copied to the smart card. The specific file in the database is linked to the smart card, designated institution terminals, merchant terminals and accounts, and to the corresponding funder's account at a networked financial institution.

The invention includes multiple functions associated with the smart card, such as access and eligibility utilities, voting, financial instrument payment and cashless purchasing that may be restricted to certain types of purchases.

After registration, a funder can designate values in one or more pockets of the electronic purse of the smart card. Each pocket may be restricted to a certain category use. In the preferred embodiment, the smart card contains five pockets, but the system can be adapted to include more or less. Each pocket may be designated with a different value. The funder also has the option of not allocating a value a given pocket. Values in the pockets are associated with funds specified from and held in the funder's charge card or bank account drawn on a specific networked financial institution. The financial institution may be linked to the system via the Internet. The electronic purse information is stored on the card as well as in the system database. The funder's account information is stored in the card user's specific file in the system's database.

Merchants in the system include the institution of the card user, such as the campus in the preferred embodiment, offline and networked coin operated machines, and web-based as well as bricks and mortar point of sale sites. Merchants are predetermined by terminal. Each merchant has a corresponding electronic file in the database linked by the system to match transactions to merchants via a merchant identification code.

Based upon the pockets designated by the funder, the smart card allows the cardholder to transact electronic payments for a variety of purchases. On-line, institutional, and non-institutional sites will display a logo to alert the user that the system may be used at that location to make electronic purchases.

In the example, the card may be used off campus where off-campus merchants accept the card for payment at the point of sale. National chain merchants as well as local community merchants are part of the network for electronic cash payments in a variety of environments, including food, books, clothing and services. The card may be designated for use at an ATM in the network or to make on-line purchases.

The card may also be used for on campus purchases, such as food, books, vending machines, recreation and other services. Smart card service options include online services, such as laundry, copying, and library services that are networked with the system. A user may use the card to access products from offline vending machines enrolled in the system. The system has a listing of local vending machines accessible to the user. A given pocket on the smart card may be restricted to school related financial transactions, such as electronic movement of financial aid and payment of student loans. Parents may fund a pocket with cash located in a separate account. The system debits the funder account when the card is used for a school related financial transaction.

All use of the smart card purse is logged on the database. If a cardholder attempts to make a purchase with the smart card for a purchase that has not been authorized by the funder or from a pocket is empty, the purchase will be denied at the point of sale.

Information stored on the card allows access to institution elements such as library privileges that enable the card user to check out books as well as rent presentation equipment. The card also is used for to determine eligibility such as use of a chemistry lab or voting in a student election. All use of the card related to access and eligibility are linked to the institution terminal and the system's database.

The user may also access the Internet using the card for e-mail services, community and institutional news and other information. The user may access a map of his or her institution with locations of networked and offline vending machines, copy machines, and other coin-operated devices that accept the smart card. The card user may also vote in campus elections and may function as a calling card with access to phone services.

All use of the card is via an encrypted security system. All transactions related to each of the multiple functions performed with the smart card are recorded in the database. Purchase transactions are uploaded to the database from a merchant terminal or institutional terminal and are settled in a batch process. All merchant terminals, institutional terminals and funder financial institutions are linked to user files in the database of the system via a network, such as the Internet. Based upon purchase transaction information collected by the system at each merchant and institutional terminal, funds corresponding to specific card user purchase transactions are moved electronically from the funder's account at the financial institution to merchant or institutional accounts. Settlement occurs at timed intervals, preferably, daily.

Transaction information related to purchases is processed and report summaries are generated for each card user to allow review by card users, funders, institutions and merchants on a periodic basis, preferably monthly. In the preferred embodiment, a parent can review a student's purchases and use of the smart card, a school can review a student's access to a certain campus building, an on-campus merchant can review commissary use, and an off-campus merchant can review general and specific card transactions.

A log of the use of the card for access and eligibility is generated for the user, the funder and the institution. The system also processes transactional information by individual cardholder to generate loyalty information. Based on certain parameters, rewards and special program offers are triggered by the system and sent by e-mail to the card user or funder.

Having described the invention in detail, those skilled in the art will appreciate that, given the present disclosure, modifications may be made to the invention without departing from the spirit of the inventive concept herein described. Rather, it is intended that the scope of the invention be determined by the appended claims.

We claim:

1] A smart card having a purse with a plurality of pockets, each pocket having a value and a predetermined purpose associated therewith and being restricted with respect to transactions such that an expenditure of value associated with the pocket is limited to the predetermined purpose of the pocket.

2] The smart card of claim 1 in which a restriction of a pocket purpose is determined according to data associated with the card accessed from an external database operatively interconnectable to the card.

3] The smart card of claim 1 in which the value of a pocket is determined according to data associated with the card accessed from an external database operatively interconnectable to the card.

4] A transaction system including the smart card of claim 1 and:
a smart card terminal for populating data on the smart card concerning a card user and for registering a stored value having a restricted purpose in at least one of the pockets;
a funds terminal wherein funds data associated with an account from which funds registered to a smart card pocket is entered;
a merchant terminal operable with the smart card wherein merchant data, including a merchant account, and merchant purchase data with respect to use of the smart card are entered;
an institution terminal operable with the smart card wherein institution and card user data and institution use data with respect to use of the smart card are entered;
a network interconnecting the smart card terminal, the funds terminal, the merchant terminal, and the institution terminal with a central processing unit, the central processing unit operatively interconnected with a database containing records of data associated with a card user, stored values having a restricted purpose in a pocket on the card user's card; funds associated with an account from which funds registered to a smart card pocket; a merchant, a merchant account and merchant purchases with respect to use of the smart card; and an institution and institution use data with respect to use of the smart card;
the central processing unit operable upon receipt of a data signal in the network from at least one of the smart card terminal, the funds terminal, the merchant terminal and the institution terminal, the central processing unit processing the data in the signal with respect to a card user, stored values having a restricted purpose in a pocket on the card user's card; funds associated with an account from which funds registered to a smart card pocket; a merchant and merchant purchases with respect to use of the smart card; and an institution and institution use data with respect to use of the smart card; according to predetermined criteria associated with the interrelationship of a card user, stored values having a restricted purpose in a pocket on the card user's card;
funds associated with an account from which funds registered to a smart card pocket; a merchant, a merchant account and merchant purchases with respect to use of the smart card; and an institution and institution use data with respect to use of the smart card;

5] The system of claim 4 in which the CPU transmits a software application comprising an executable card interface from the CPU for storage on the smart card terminal upon a request from the smart card terminal.

6] The system of claim 5 in which the software application is a Java applet.

7] The system of claim 4 further comprising a settlement in which the CPU calculates funds debits and credits owing from and payable to the different pockets of the card and owing from and payable to the account from which the funds are registered and owing from and payable to the merchant account with respect to the smart card.

8] The settlement system of claim 7 in which the mechanism for calculating is controlled by a predetermined event.

9] The settlement system of claim 7 in which the mechanism for calculating is controlled by a predetermined schedule.

10] The settlement system of claim 8 in which the registration of value in card pockets, and the debiting of funds between the account from which the funds are registered to the card, and the merchant terminal is based upon activation of the central processing unit by the card.

11] The smart card of claim 1 including a functionality in addition to stored value in controlled access pockets.

12] The smart card of claim 11 in which the functionality is one of accessibility, eligibility and network privileges.
